(19) United States
(12) Patent Application Publication
(10) Pub. No.: US 2023/0308650 A1
(43) Pub. Date: Sep. 28, 2023

(54) IMAGE PROCESSING DEVICE, IMAGE PROCESSING METHOD, AND COMPUTER-READABLE RECORDING MEDIUM STORING IMAGE PROCESSING PROGRAM

(71) Applicant: FUJITSU LIMITED, Kawasaki-shi (JP)

(72) Inventors: Tomonori KUBOTA, Kawasaki (JP); Takanori NAKAO, Kawasaki (JP)

(73) Assignee: FUJITSU LIMITED, Kawasaki-shi (JP)

(21) Appl. No.: 18/328,846

(22) Filed: Jun. 5, 2023

Related U.S. Application Data
(63) Continuation of application No. PCT/JP2021/002221, filed on Jan. 22, 2021.

(51) Int. Cl. H04N 19/176; H04N 19/136; G06V 10/77; H04N 19/124; H04N 19/152

(52) U.S. Cl. CPC H04N 19/124; G06V 10/7715; H04N 19/136; H04N 19/152; H04N 19/176

(57) ABSTRACT

An image processing device includes: a memory; and a processor coupled to the memory and configured to: determine whether or not overflow occurs in a virtual buffer when image data of each frame of moving image data is encoded; refer to recognition object information in a case where it is determined that the overflow occurs; and change a quantization value of a block at a position that corresponds to an area of an object to be recognized other than an object to be recognized specified by the recognition object information among objects to be recognized included in the image data to a quantization value higher than a quantization value that corresponds to a limit compression ratio.

### CROSS-REFERENCE TO RELATED APPLICATION

This application is a continuation application of International Application PCT/JP2021/002221 filed on Jan. 22, 2021 and designated the U.S., the entire contents of which are incorporated herein by reference.

### FIELD

The embodiments discussed herein are related to an image processing device, an image processing method, and an image processing program.

### BACKGROUND

In a case where moving image data is encoded and transmitted, for example, bit rate control is performed to perform the encoding at a compression ratio corresponding to a transmission load.

Japanese Laid-open Pat. Publication No. 2019-050896 and Japanese Laid-open Pat. Publication No. 2020-003785 are disclosed as related art.

### SUMMARY

According to an aspect of the embodiments, an image processing device includes: a memory; and a processor coupled to the memory and configured to: determine whether or not overflow occurs in a virtual buffer when image data of each frame of moving image data is encoded; refer to recognition object information in a case where it is determined that the overflow occurs; and change a quantization value of a block at a position that corresponds to an area of an object to be recognized other than an object to be recognized specified by the recognition object information among objects to be recognized included in the image data to a quantization value higher than a quantization value that corresponds to a limit compression ratio.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a first diagram illustrating an example of a system configuration of an image processing system;

FIGS. 2A and 2B are diagrams illustrating an example of hardware configurations of an image processing device and a server device;

FIG. 3 is a first diagram illustrating an example of a functional configuration of an analysis unit of the image processing device;

FIG. 4 is a diagram illustrating a specific example of processing of a convolutional neural network (CNN) unit and an important feature map generation unit;

FIGS. 5A and 5B are diagrams illustrating a specific example of processing of an aggregation unit;

FIG. 6 is a diagram illustrating a specific example of processing of a quantization value map generation unit;

FIG. 7 is a first diagram illustrating an example of a functional configuration of a bit rate control unit of the image processing device;

FIG. 8 is a first flowchart illustrating a flow of image processing by the image processing device;

FIG. 9 is a second diagram illustrating an example of a functional configuration of an analysis unit of an image processing device;

FIG. 10 is a diagram illustrating a specific example of processing of a CNN unit and a signal intensity calculation unit;

FIG. 11 is a second flowchart illustrating a flow of image processing by the image processing device;

FIG. 12 is a second diagram illustrating an example of a system configuration of an image processing system;

FIG. 13 is a third diagram illustrating an example of a functional configuration of an analysis unit of an image processing device;

FIG. 14 is a second diagram illustrating an example of a functional configuration of a bit rate control unit of the image processing device;

FIG. 15 is a third flowchart illustrating a flow of image processing by the image processing device;

FIG. 16 is a fourth diagram illustrating an example of a functional configuration of an analysis unit of an image processing device; and

FIG. 17 is a fourth flowchart illustrating a flow of image processing by the image processing device.

### DESCRIPTION OF EMBODIMENTS

Meanwhile, in the case of encoding and transmitting moving image data for the purpose of use in recognition processing by artificial intelligence (AI), for example, it is conceivable to perform the encoding by increasing a compression ratio to a limit at which the AI may recognize an object to be recognized (for example, at a limit compression ratio).

However, even in a case where encoding is performed at the limit compression ratio, it is conceivable that overflow will occur in a virtual buffer. In such a case, when a compression ratio of each block is uniformly increased beyond the limit compression ratio, it becomes difficult to recognize all objects to be recognized included in the moving image data by the AI, and recognition accuracy deteriorates significantly.

In one aspect, an object is to suppress deterioration in recognition accuracy in a case where encoding is performed at a compression ratio exceeding a limit compression ratio that may be recognized by artificial intelligence (AI).

Hereinafter, each embodiment will be described with reference to the accompanying drawings. Note that, in the present specification and the drawings, components having substantially the same functional configuration are denoted by the same reference signs, and redundant description will be omitted.

### 0029 First Embodiment

### <System Configuration of Image Processing System>

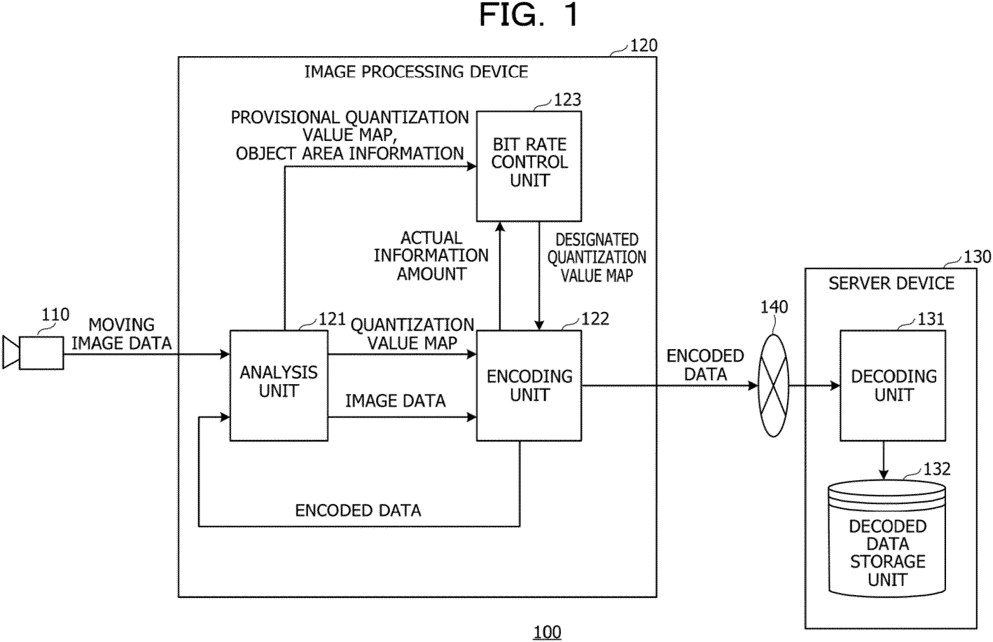

First, a system configuration of an entire image processing system including an image processing device according to a first embodiment will be described. FIG. 1 is a first diagram illustrating an example of the system configuration of the image processing system. As illustrated in FIG. 1, an image processing system 100 includes an imaging device 110, an image processing device 120, and a server device 130. In the image processing system 100, the image processing device 120 and the server device 130 are communicably coupled via a network 140.

The imaging device 110 performs imaging at a predetermined frame period, and transmits moving image data to the image processing device 120. Note that the moving image data includes at least image data of a frame including an object targeted for recognition processing (object to be recognized) and image data of a frame (including only an object not to be recognized) not including the object targeted for the recognition processing (object to be recognized). Moreover, the moving image data may include image data of a frame that does not include any object.

An image processing program is installed in the image processing device 120, and when the image processing program is executed, the image processing device 120 functions as an analysis unit 121, an encoding unit 122, and a bit rate control unit 123.

The analysis unit 121 includes a trained model that performs the recognition processing. The analysis unit 121 performs the recognition processing by inputting, to the trained model, image data or decoded data (decoded data obtained by decoding encoded data of a case where encoding processing is performed for the image data at different quantization values (also referred to as quantization steps)) of each frame of the moving image data.

Furthermore, at the time of the recognition processing, the analysis unit 121 generates a map (referred to as an “important feature map”) indicating a degree of influence on a recognition result by performing motion analysis for the trained model by using, for example, an error back propagation method, and aggregates the degree of influence for each predetermined area. Note that the predetermined area mentioned here refers to a block used when the encoding processing is performed.

Furthermore, the analysis unit 121 instructs the encoding unit 122 to perform the encoding processing with a predetermined number of different quantization values, and repeats processing similar to that described above for each piece of decoded data obtained by decoding encoded data of a case where the encoding processing is performed for the image data with each quantization value. Note that a set of the quantization values for each block, which is instructed to the encoding unit 122, is hereinafter referred to as a “quantization value map”.

For example, while changing image quality of the image data input to the trained model by changing the quantization value map, the analysis unit 121 aggregates the degree of influence of each block on the recognition result, for each piece of the image data after the change.

Furthermore, the analysis unit 121 searches for an optimum quantization value of each block based on a change in an aggregated value due to the change in the quantization value map. Note that the optimum quantization value refers to a quantization value corresponding to a limit compression ratio, at which the object to be recognized included in the image data may be correctly recognized, among the predetermined number of different quantization values. A set of the quantization values corresponding to the limit compression ratio calculated for each block is referred to as a “provisional quantization value map” in the present embodiment.

Furthermore, the analysis unit 121 notifies the bit rate control unit 123 of the provisional quantization value map and information indicating an area of the object to be recognized (“object area information”). Note that the object area information is calculated based on a recognition result output from the trained model by performing the recognition processing for the image data.

The encoding unit 122 performs the encoding processing for the image data of the corresponding frame of the moving image data by using the quantization value map instructed from the analysis unit 121, and returns generated encoded data to the analysis unit 121.

Furthermore, the encoding unit 122 notifies the bit rate control unit 123 of an information amount (actual information amount) of the encoded data measured when the encoding processing is performed for image data of a frame to be processed last time. Moreover, the encoding unit 122 performs the encoding processing for image data of a frame to be processed this time by using a designated quantization value map notified from the bit rate control unit 123 in response to the notification of the actual information amount, and transmits encoded data to the server device 130.

The bit rate control unit 123 calculates a “virtual buffer position” indicating a current remaining amount of a virtual buffer based on the acquired actual information amount. Furthermore, the bit rate control unit 123 predicts a change in the virtual buffer position in a case where the encoding processing is performed for the image data of the frame to be processed this time by using the provisional quantization value map.

Furthermore, the bit rate control unit 123 determines whether or not overflow occurs in the virtual buffer based on the virtual buffer position after the predicted change. In a case where it is determined that no overflow occurs, the bit rate control unit 123 notifies the encoding unit 122 of the provisional quantization value map as the designated quantization value map.

On the other hand, in a case where it is determined that the overflow occurs, the bit rate control unit 123 specifies an object to be recognized other than an object to be recognized specified in advance among objects to be recognized indicated by the object area information. Moreover, the bit rate control unit 123 changes a quantization value of a block at a position corresponding to an area of the specified object to be recognized in the provisional quantization value map to a quantization value higher than the quantization value corresponding to the limit compression ratio. Then, the bit rate control unit 123 notifies the encoding unit 122 of the provisional quantization value map after the change in which the quantization value has been changed as the designated quantization value map.

In this manner, in a case where it is determined that the overflow occurs in the virtual buffer, the bit rate control unit 123 performs the encoding processing at a compression ratio exceeding the limit compression ratio for the area of the object to be recognized other than the object to be recognized specified in advance in the provisional quantization value map. With this configuration, it is possible to maintain recognition accuracy for the object to be recognized specified in advance while avoiding the overflow in the virtual buffer. For example, according to the image processing device 120, it is possible to suppress deterioration in the recognition accuracy in a case where encoding is performed at the compression ratio exceeding the limit compression ratio that may be recognized by artificial intelligence (AI).

A decoding program is installed in the server device 130, and when the decoding program is executed, the server device 130 functions as a decoding unit 131.

The decoding unit 131 decodes the encoded data transmitted from the image processing device 120 to generate decoded data. The decoding unit 131 stores the generated decoded data in a decoded data storage unit 132.

### <Hardware Configurations of Image Processing Device and Server Device>

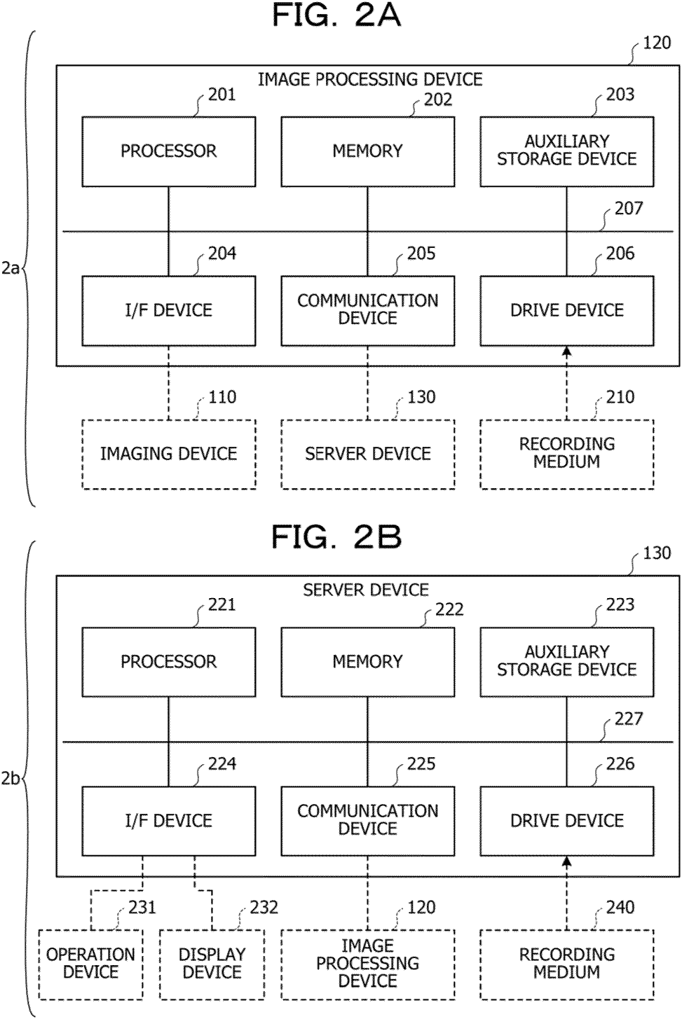

Next, hardware configurations of the image processing device 120 and the server device 130 will be described. FIGS. 2A and 2B are diagrams illustrating an example of the hardware configurations of the image processing device and the server device.

Among these, FIG. 2A is a diagram illustrating an example of the hardware configuration of the image processing device. The image processing device 120 includes a processor 201, a memory 202, an auxiliary storage device 203, an interface (I/F) device 204, a communication device 205, and a drive device 206. Note that the respective pieces of hardware of the image processing device 120 are coupled to each other via a bus 207.

The processor 201 includes various arithmetic devices such as a central processing unit (CPU) or a graphics processing unit (GPU). The processor 201 reads various programs (for example, the image processing program and the like) into the memory 202 and executes the programs.

The memory 202 includes a main storage device such as a read only memory (ROM) or a random access memory (RAM). The processor 201 and the memory 202 form a so-called computer. The processor 201 executes the various programs read into the memory 202 to cause the computer to implement various functions.

The auxiliary storage device 203 stores various programs and various pieces of data used when the various programs are executed by the processor 201.

The I/F device 204 is a coupling device that couples the imaging device 110, which is an example of an external device, and the image processing device 120.

The communication device 205 is a communication device for communicating with the server device 130, which is an example of another device.

The drive device 206 is a device for setting a recording medium 210. The recording medium 210 mentioned here includes a medium that optically, electrically, or magnetically records information, such as a compact disc read only memory (CD-ROM), a flexible disk, or a magneto-optical disk. Furthermore, the recording medium 210 may include a semiconductor memory or the like that electrically records information, such as a ROM or a flash memory.

Note that the various programs to be installed in the auxiliary storage device 203 are installed when, for example, the distributed recording medium 210 is set in the drive device 206, and the various programs recorded in the recording medium 210 are read by the drive device 206. Alternatively, the various programs to be installed in the auxiliary storage device 203 may be installed by being downloaded from a network via the communication device 205.

On the other hand, FIG. 2B is a diagram illustrating an example of the hardware configuration of the server device 130. Note that since the hardware configuration of the server device 130 is substantially the same as the hardware configuration of the image processing device 120, differences from the image processing device 120 will be mainly described here.

A processor 221 reads, for example, a decoding program and the like into a memory 222 and executes the decoding program and the like. An auxiliary storage device 223 implements, for example, the decoded data storage unit 132.

An I/F device 224 receives an operation for the server device 130 via an operation device 231. Furthermore, the I/F device 224 outputs a result of processing by the server device 130, and displays the result via a display device 232. Furthermore, a communication device 225 communicates with the image processing device 120.

### <Functional Configuration of Analysis Unit of Image Processing Device>

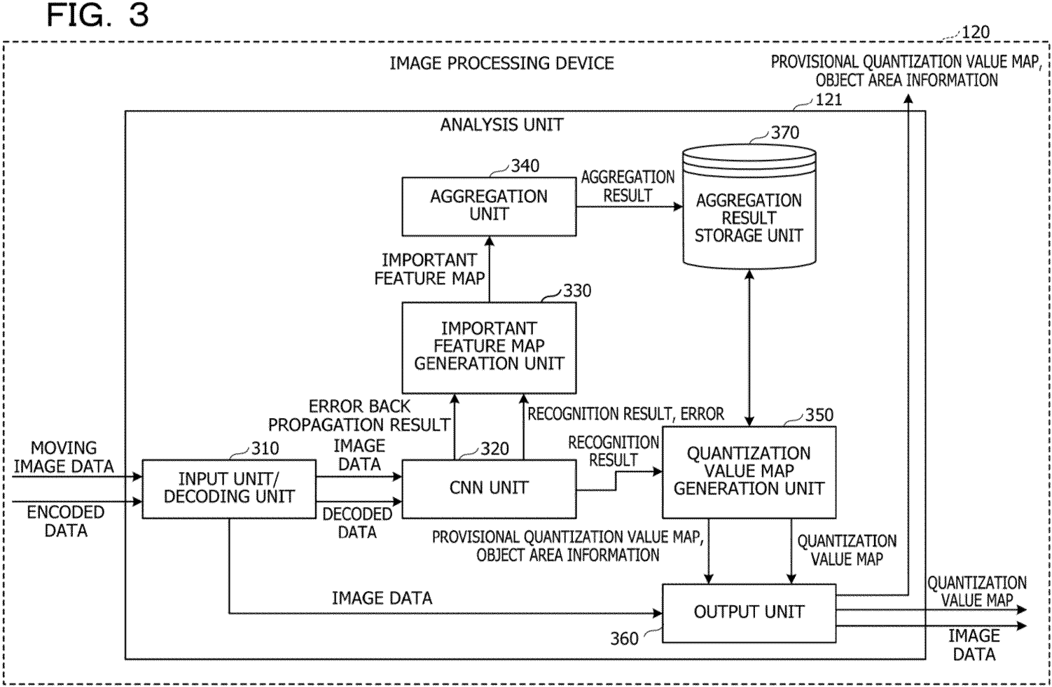

Next, a functional configuration of the analysis unit 121 of the image processing device 120 will be described. FIG. 3 is a first diagram illustrating an example of the functional configuration of the analysis unit of the image processing device. As illustrated in FIG. 3, the analysis unit 121 includes an input unit/decoding unit 310, a convolutional neural network (CNN) unit 320, an important feature map generation unit 330, an aggregation unit 340, a quantization value map generation unit 350, and an output unit 360.

The input unit/decoding unit 310 acquires image data of each frame of moving image data transmitted from the imaging device 110, and notifies the CNN unit 320 of the acquired image data. Furthermore, the input unit/decoding unit 310 acquires and decodes encoded data notified from the encoding unit 122, and then notifies the CNN unit 320 of the decoded data.

The CNN unit 320 includes the trained model that performs the recognition processing. The CNN unit 320 causes the trained model to be executed by inputting the image data or the decoded data. Furthermore, the CNN unit 320 notifies the important feature map generation unit 330 and the quantization value map generation unit 350 of a recognition result output from the trained model by inputting the image data.

Furthermore, the CNN unit 320 notifies the important feature map generation unit 330 of a recognition result output from the trained model by inputting the decoded data.

The important feature map generation unit 330 acquires the recognition results output from the trained model. Furthermore, the important feature map generation unit 330 generates an important feature map by the error back propagation method by using the acquired recognition results.

For example, the important feature map generation unit 330 calculates an error between the recognition result acquired when the image data is input and the recognition result acquired when the decoded data is input. Furthermore, the important feature map generation unit 330 acquires an error back propagation result from an input layer of the trained model by backpropagating the calculated error. Moreover, the important feature map generation unit 330 generates an important feature map based on the acquired error back propagation result, and notifies the aggregation unit 340 of the generated important feature map.

Note that details of the method of generating the important feature map by the error back propagation method is disclosed in documents such as

“Selvaraju, Ramprasaath R., et al. ‘Grad-cam: Visual explanations from deep networks via gradient-based localization’, The IEEE International Conference on Computer Vision (ICCV), 2017, pp. 618-626”, for example.

The aggregation unit 340 aggregates a degree of influence of each area on the recognition result in units of blocks based on the notified important feature map, and calculates an aggregated value of the degree of influence for each block. Furthermore, the aggregation unit 340 stores the calculated aggregated value of each block in an aggregation result storage unit 370 in association with the quantization value used for the encoding processing.

The quantization value map generation unit 350 generates a quantization value map while sequentially changing the quantization value for each block, and notifies the output unit 360 of the generated quantization value map. Note that it is assumed that a range of the change when the quantization value is sequentially changed is determined in advance.

Furthermore, the quantization value map generation unit 350 searches for a quantization value corresponding to the limit compression ratio for each block based on an aggregation result stored in the aggregation result storage unit 370 to generate a provisional quantization value map, and notifies the output unit 360 of the generated provisional quantization value map.

Moreover, the quantization value map generation unit 350 generates information indicating an area of the object to be recognized (object area information) based on the recognition result acquired from the CNN unit 320, and notifies the output unit 360 of the generated information.

The output unit 360 notifies the encoding unit 122 of the quantization value map generated by the quantization value map generation unit 350. Furthermore, the output unit 360 notifies the encoding unit 122 of the image data of the corresponding frame of the moving image data. Moreover, the output unit 360 notifies the bit rate control unit 123 of the provisional quantization value map and the object area information generated by the quantization value map generation unit 350.

### <Specific Example of Processing of CNN Unit and Important Feature Map Generation Unit>

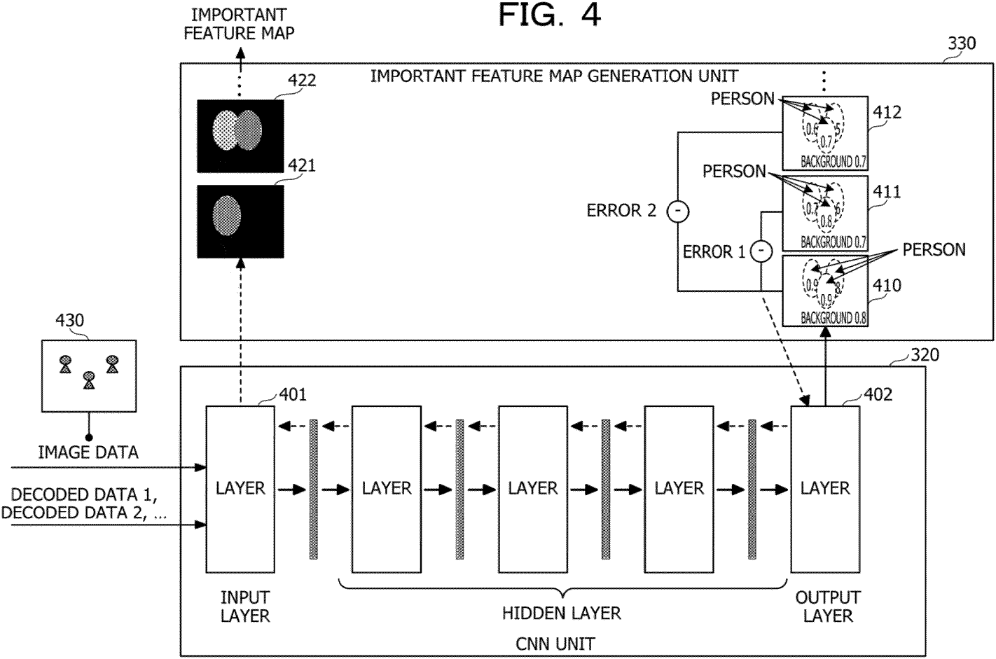

Next, a specific example of processing of the CNN unit 320 and the important feature map generation unit 330 among the respective units constituting the analysis unit 121 will be described. FIG. 4 is a first diagram illustrating the specific example of the processing of the CNN unit and the important feature map generation unit.

As illustrated in FIG. 4, the CNN unit 320 includes an input layer, hidden layers, and an output layer as the trained model, and when image data is input to a layer 401 of the input layer, the image data is processed in a forward propagation direction in each layer. With this configuration, a recognition result 410 is output from a layer 402 of the output layer (see a solid thick arrow). Note that the example of FIG. 4 indicates a state where image data 430 including three “persons” which are examples of objects to be recognized is input.

Similarly, when decoded data 1 is input to the layer 401 of the input layer, the decoded data 1 is processed in the forward propagation direction in each layer, and a recognition result 411 is output from the layer 402 of the output layer (see the solid thick arrow). Note that the decoded data 1 refers to, for example, data obtained by performing the encoding processing for each block of the image data 430 with a quantization value map that is a set of quantization values Q₁ and thereafter decoding the encoded data by the input unit/decoding unit 310.

Similarly, when decoded data 2 is input to the layer 401 of the input layer, the decoded data 2 is processed in the forward propagation direction in each layer, and a recognition result 412 is output from the layer 402 of the output layer (see the solid thick arrow). Note that the decoded data 2 refers to, for example, data obtained by performing the encoding processing for each block of the image data 430 with a quantization value map that is a set of quantization values Q₂ and thereafter decoding the encoded data by the input unit/decoding unit 310.

Hereinafter, although not illustrated in FIG. 4, decoded data 3, decoded data 4, ..., and the like are similarly processed, and recognition results are output.

Furthermore, as illustrated in FIG. 4, the important feature map generation unit 330 calculates each of errors (errors 1, 2, ...) between
the recognition result 410 output by processing the image data in the forward propagation direction, and
each of the recognition results (recognition results 411, 412, ...) output by processing each piece of the decoded data (decoded data 1, 2, ...) in the forward propagation direction.

Furthermore, the important feature map generation unit 330 backpropagates each of the calculated errors (errors 1, 2, ...) from the layer 402 of the output layer. With this configuration, each of important feature maps (important feature maps 421, 422, ...) is output from the layer 401 of the input layer of the CNN unit 320 as an error back propagation result (see a dotted thick arrow). The important feature map generation unit 330 notifies the aggregation unit 340 of each of the important feature maps (important feature maps 421, 422, ...) output from the CNN unit 320.

### <Specific Example of Processing of Aggregation Unit>

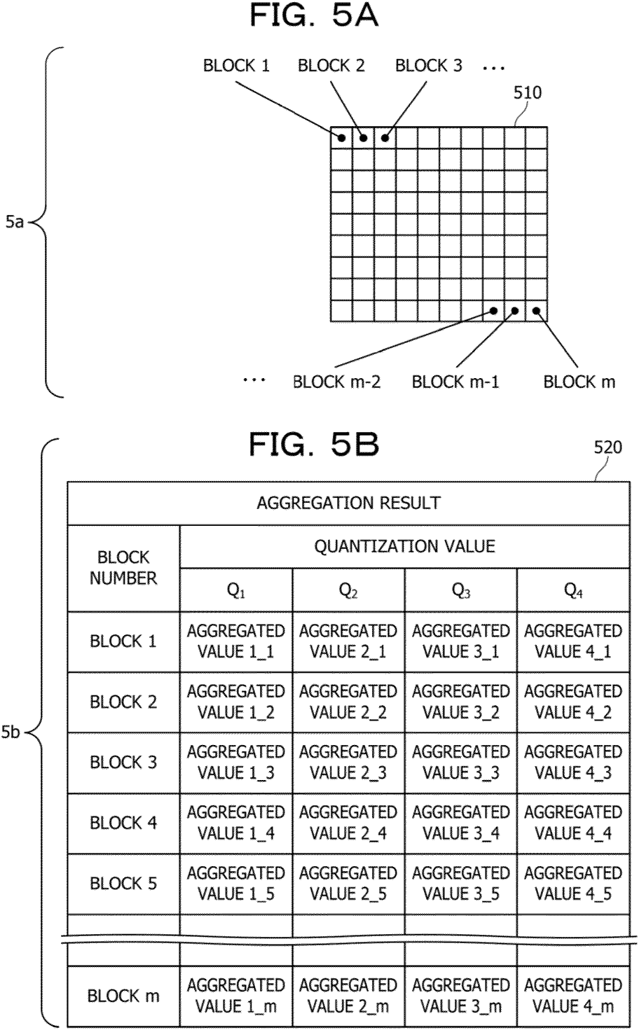

Next, a specific example of processing of the aggregation unit 340 among the respective units constituting the analysis unit 121 will be described. FIGS. 5A and 5B are diagrams illustrating the specific example of the processing of the aggregation unit. Among these, FIG. 5A illustrates an arrangement example of blocks used when the encoding processing is performed for image data 510. As illustrated in FIG. 5A, in the present embodiment, for simplification of description, it is assumed that all the blocks in the image data 510 have the same dimensions. Furthermore, in the example of FIG. 5A, a block number of an upper left block of the image data 510 is assumed as “block 1”, and a block number of a lower right block is assumed as “block m”.

Furthermore, as illustrated in FIG. 5B, an aggregation result 520 calculated by the aggregation unit 340 includes “block number” and “quantization value” as information items.

In the “block number”, a block number of each block in the image data 510 is stored. In the “quantization value”, a predetermined number of quantization values settable when the encoding unit 122 performs the encoding processing are stored.

Note that, in the example of FIG. 5B, for simplification of description, only four types of quantization values (“Q₁” to “Q₄”) are described. However, it is assumed that four or more types of quantization values are settable in the encoding processing by the encoding unit 122.

Furthermore, in the aggregation result 520, an “aggregated value” obtained by
performing the encoding processing for the image data 510 by using the corresponding quantization value, and
being aggregated in the corresponding block based on the important feature map calculated when the recognition processing is performed for the decoded data
is stored in a field associated with the “block number” and the “quantization value”.

### <Specific Example of Processing by Quantization Value Map Generation Unit>

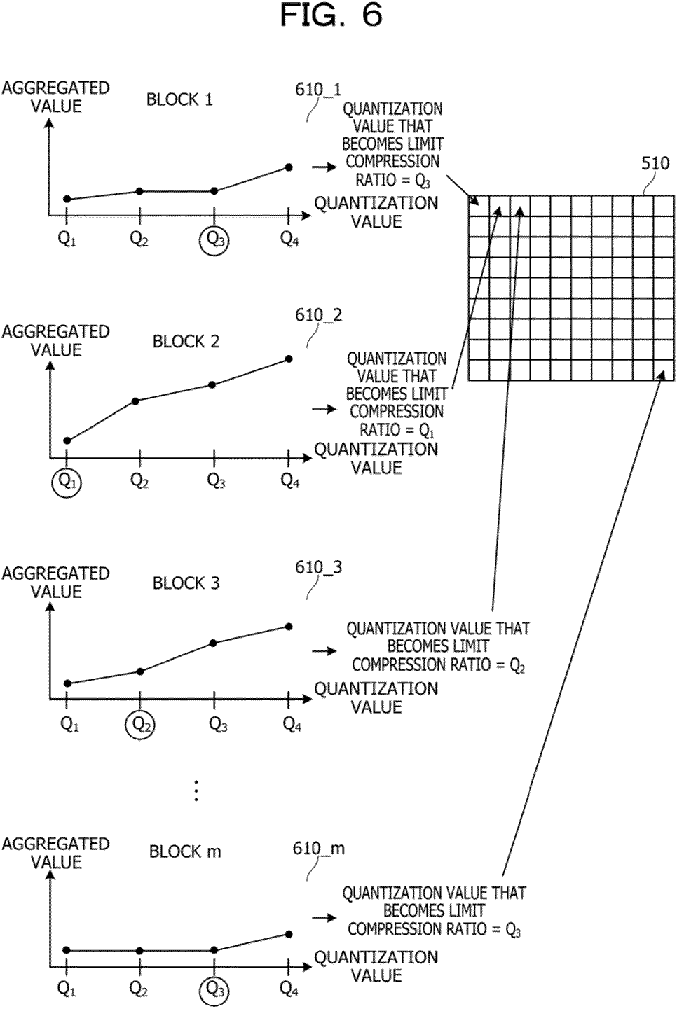

Next, a specific example of processing by the quantization value map generation unit 350 among the respective units constituting the analysis unit 121 will be described. FIG. 6 is a diagram illustrating the specific example of the processing by the quantization value map generation unit. In FIG. 6, graphs 610_1 to 610_m are graphs generated by plotting the aggregated value of each block included in the aggregation result 520, with the quantization value on a horizontal axis and the aggregated value on a vertical axis.

As illustrated in the graphs 610_1 to 610_m, a change in the aggregated value in a case where the encoding processing is performed by using each quantization value differs for each block. The quantization value map generation unit 350 determines, for example, the quantization value that satisfies any of the following conditions:
in a case where magnitude of the aggregated value exceeds a predetermined threshold,
in a case where an amount of change in the aggregated value exceeds a predetermined threshold,
in a case where a slope of the aggregated value exceeds a predetermined threshold, or
in a case where a change in the slope of the aggregated value exceeds a predetermined threshold,
as the quantization value corresponding to the limit compression ratio of each block.

The example of FIG. 6 indicates that the quantization value map generation unit 350 determines the quantization value corresponding to the limit compression ratio as “Q₃” based on the graph 610_1. Furthermore, the example of FIG. 6 indicates that the quantization value map generation unit 350 determines the quantization value corresponding to the limit compression ratio as “Q₁” based on the graph 610_2. Furthermore, the example of FIG. 6 indicates that the quantization value map generation unit 350 determines the quantization value corresponding to the limit compression ratio as “Q₂” based on the graph 610_3. Moreover, the example of FIG. 6 indicates that the quantization value map generation unit 350 determines the quantization value corresponding to the limit compression ratio as “Q₃” based on the graph 610_m.

The example of FIG. 6 indicates a state where the quantization value corresponding to the limit compression ratio is set for each of the blocks 1 to m in the image data 510 to generate the provisional quantization value map.

### <Functional Configuration of Bit Rate Control Unit>

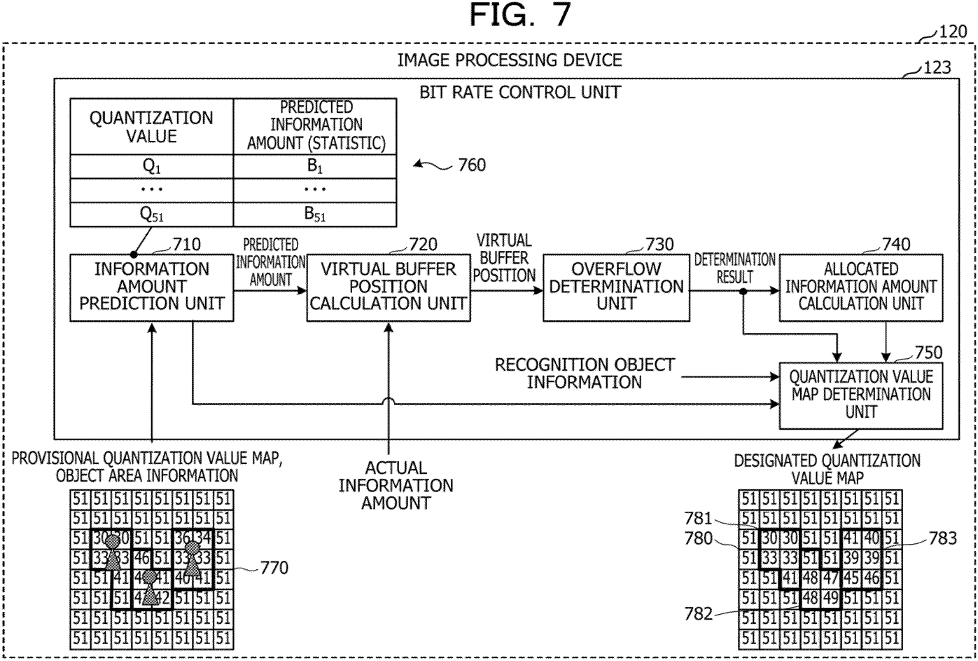

Next, a functional configuration of the bit rate control unit 123 of the image processing device 120 will be described. FIG. 7 is a first diagram illustrating an example of the functional configuration of the bit rate control unit of the image processing device. As illustrated in FIG. 7, the bit rate control unit 123 includes an information amount prediction unit 710, a virtual buffer position calculation unit 720, an overflow determination unit 730, an allocated information amount calculation unit 740, and a quantization value map determination unit 750.

Among these, the information amount prediction unit 710 specifies an information amount (predicted information amount) of encoded data in a case where the encoding processing is performed for image data of a frame to be processed by using the provisional quantization value map.

Note that, as illustrated in FIG. 7, the information amount prediction unit 710 has a statistical information amount 760 (table that stores, as predicted information amounts, statistics of an information amount of the encoded data in the case where the encoding processing is performed by using each quantization value) in advance. Thus, the information amount prediction unit 710 specifies the predicted information amount by referring to the statistical information amount 760.

Furthermore, the information amount prediction unit 710 notifies the quantization value map determination unit 750 of the provisional quantization value map and the object area information notified from the analysis unit 121. Note that, in FIG. 7, a reference sign 770 represents a specific example of the provisional quantization value map and the object area information. In the reference sign 770, a numerical value in each block represents the quantization value corresponding to the limit compression ratio. Furthermore, in the reference sign 770, a thick line represents an outer edge of blocks at positions corresponding to an area of the object to be recognized (an example of the object area information). Note that, in the example of the reference sign 770, for convenience of description, the “persons” as the examples of the objects to be recognized are superimposed and displayed.

The virtual buffer position calculation unit 720 calculates a virtual buffer position based on the actual information amount acquired from the encoding unit 122. Furthermore, the virtual buffer position calculation unit 720 predicts a change in the virtual buffer position in a case where the encoding processing is performed for the image data of the frame to be processed by using the provisional quantization value map based on the virtual buffer position and the predicted information amount.

The overflow determination unit 730 is an example of a determination unit, and determines whether or not overflow occurs based on a prediction result of the virtual buffer position after the change predicted by the virtual buffer position calculation unit 720. Furthermore, in a case where it is determined that no overflow occurs, the overflow determination unit 730 notifies the quantization value map determination unit 750 of the determination result. On the other hand, in a case where it is determined that the overflow occurs, the overflow determination unit 730 notifies the allocated information amount calculation unit 740 of the determination result.

The allocated information amount calculation unit 740 calculates, in a case where the determination result that the overflow occurs is notified from the overflow determination unit 730, an allocatable information amount of the encoded data based on the virtual buffer position calculated by the virtual buffer position calculation unit 720. Furthermore, the allocated information amount calculation unit 740 notifies the quantization value map determination unit 750 of the allocatable information amount of the encoded data.

The quantization value map determination unit 750 is an example of a change unit, and generates the designated quantization value map. For example, in a case where the determination result that no overflow occurs is notified from the overflow determination unit 730, the quantization value map determination unit 750 notifies the encoding unit 122 of the provisional quantization value map notified from the information amount prediction unit 710 as the designated quantization value map.

On the other hand, in a case where the allocatable information amount of the encoded data is notified from the allocated information amount calculation unit 740, the quantization value map determination unit 750 refers to “recognition object information”. Note that, in the recognition object information, it is assumed that an object to be recognized to be preferentially recognized in a case where there is a possibility that the overflow occurs in the virtual buffer is specified in advance. Furthermore, in the recognition object information, a method of specifying the object to be recognized to be preferentially recognized is optional, and for example, it is assumed that the method is specified depending on an attribute, a size, a position, or the like of the object to be recognized.

Then, the quantization value map determination unit 750 specifies an object to be recognized other than the object to be recognized specified by the recognition object information among the plurality of objects to be recognized included in the image data (for example, the plurality of objects to be recognized included in the object area information notified from the information amount prediction unit 710). Furthermore, the quantization value map determination unit 750 changes a quantization value of a block at a position corresponding to an area of the specified object to be recognized in the provisional quantization value map notified from the information amount prediction unit 710 to a quantization value higher than the quantization value corresponding to the limit compression ratio.

At this time, the quantization value map determination unit 750 determines a change width of the quantization value based on the allocatable information amount of the encoded data notified from the allocated information amount calculation unit 740. Moreover, the quantization value map determination unit 750 notifies the encoding unit 122 of the provisional quantization value map after the change in which the quantization value has been changed as the designated quantization value map.

Note that, in FIG. 7, a reference sign 780 indicates an example of the provisional quantization value map after the change in which the quantization value has been changed. The example of the reference sign 780 indicates that, among objects to be recognized 781 to 783, quantization values of blocks at positions corresponding to areas of the objects to be recognized 782 and 783 other than the object to be recognized 781 specified in the recognition object information are changed to quantization values higher than the quantization value corresponding to the limit compression ratio.

### <Flow of Image Processing>

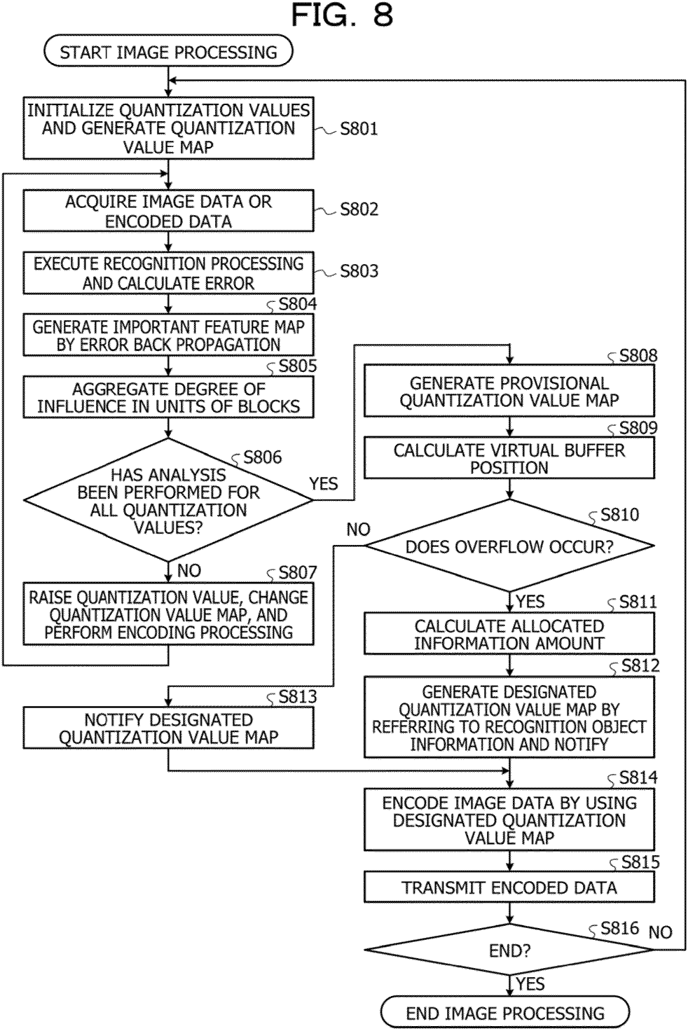

Next, a flow of image processing by the image processing device 120 will be described. FIG. 8 is a first flowchart illustrating the flow of the image processing by the image processing device.

In Step S801, the analysis unit 121 initializes quantization values and generates a default quantization value map.

In Step S802, the analysis unit 121 acquires image data or encoded data. Furthermore, in a case where the encoded data is acquired, the analysis unit 121 decodes the encoded data and generates decoded data.

In Step S803, the analysis unit 121 performs the recognition processing for the image data or the decoded data, outputs a recognition result, and calculates object area information. Furthermore, the analysis unit 121 calculates an error between the recognition result output by performing the recognition processing for the image data and the recognition result output by performing the recognition processing for the decoded data.

In Step S804, the analysis unit 121 generates an important feature map by backpropagating the calculated error.

In Step S805, the analysis unit 121 aggregates the generated important feature map in units of blocks and stores an aggregation result in the aggregation result storage unit 370.

In Step S806, the analysis unit 121 determines whether or not analysis has been performed for all the predetermined number of quantization values that are settable in the encoding unit 122. In a case where it is determined in Step S806 that there is a quantization value for which analysis has not been performed (in the case of NO in Step S806), the processing proceeds to Step S807.

In Step S807, the analysis unit 121 raises the quantization value and changes the quantization value map. Furthermore, the encoding unit 122 performs the encoding processing for the image data by using the changed quantization value map and generates encoded data. Thereafter, the processing returns to Step S802.

On the other hand, in a case where it is determined in Step S806 that analysis has been performed for all the quantization values (in the case of YES in Step S806), the processing proceeds to Step S808.

In Step S808, the analysis unit 121 searches for a quantization value corresponding to the limit compression ratio for each block and generates a provisional quantization value map. The analysis unit 121 notifies the bit rate control unit 123 of the generated provisional quantization value map together with the object area information.

In Step S809, the bit rate control unit 123 acquires an actual information amount and calculates a virtual buffer position.

In Step S810, the bit rate control unit 123 determines whether or not overflow occurs in a case where the encoding processing is performed for the image data of the frame to be processed by using the provisional quantization value map.

In a case where it is determined in Step S810 that the overflow occurs (in the case of YES in Step S810), the processing proceeds to Step S811. In Step S811, the bit rate control unit 123 calculates an allocated information amount.

In Step S812, the bit rate control unit 123 refers to recognition object information and specifies an object to be recognized other than an object to be recognized specified by the recognition object information in advance among objects to be recognized indicated by the object area information. Furthermore, the bit rate control unit 123 changes a quantization value of a block at a position corresponding to an area of the specified object to be recognized in the provisional quantization value map by a change width based on an allocated information amount, and generates a designated quantization value map. Moreover, the bit rate control unit 123 notifies the encoding unit 122 of the generated designated quantization value map.

On the other hand, in a case where it is determined in Step S810 that no overflow occurs (in the case of NO in Step S810), the processing proceeds to Step S813.

In Step S813, the bit rate control unit 123 notifies the encoding unit 122 of the provisional quantization value map as the designated quantization value map.

In Step S814, the encoding unit 122 performs the encoding processing for the image data of the frame to be processed by using the notified designated quantization value map and generates encoded data.

In Step S815, the encoding unit 122 transmits the generated encoded data to the server device 130.

In Step S816, the analysis unit 121 determines whether or not the image processing is to be ended. In a case where it is determined in Step S816 that the image processing is not to be ended (in the case of NO in Step S816), the processing returns to Step S801. In this case, the analysis unit 121 initializes the quantization values and generates a default quantization value map before image data of the next frame in the moving image data is acquired.

On the other hand, in a case where it is determined in Step S816 that the image processing is to be ended (in the case of YES in Step S816), the image processing is ended.

As is clear from the above description, the image processing device 120 according to the first embodiment determines whether or not the overflow occurs in the virtual buffer when performing the encoding processing for the image data of the frame to be processed of the moving image data. Furthermore, the image processing device 120 according to the first embodiment refers to the recognition object information in a case where it is determined that the overflow occurs. Moreover, the image processing device 120 according to the first embodiment changes the quantization value of the block at the position corresponding to the area of the object to be recognized other than the object to be recognized specified by the recognition object information in advance among the objects to be recognized included in the image data to the quantization value higher than the quantization value corresponding to the limit compression ratio.

In this manner, in the first embodiment, in a case where it is determined that the overflow occurs in the virtual buffer, the encoding processing is performed at the compression ratio exceeding the limit compression ratio for the area of the object to be recognized other than the specified object to be recognized.

With this configuration, according to the first embodiment, it is possible to maintain the recognition accuracy for the object to be recognized specified in advance while avoiding the overflow in the virtual buffer. For example, according to the first embodiment, it is possible to suppress deterioration in the recognition accuracy in a case where encoding is performed at the compression ratio exceeding the limit compression ratio that may be recognized by the AI.

### Second Embodiment

In the first embodiment described above, when the provisional quantization value map is generated, the important feature map is generated by backpropagating the error between the recognition results, and the generated important feature map is aggregated in units of blocks to determine the quantization value corresponding to the limit compression ratio for each block.

On the other hand, in a second embodiment, when a provisional quantization value map is generated, signal intensity of each area of a feature map output from a layer of a hidden layer in recognition processing is aggregated in units of blocks to determine a quantization value corresponding to a limit compression ratio for each block.

Hereinafter, regarding the second embodiment, differences from the first embodiment described above will be mainly described.

### <Functional Configuration of Analysis Unit of Image Processing Device>

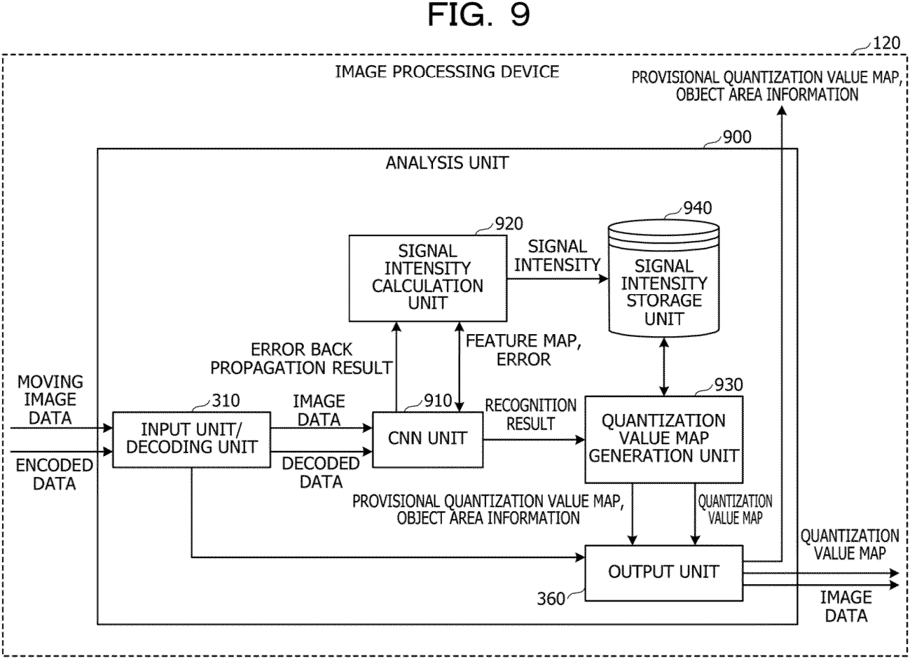

First, a functional configuration of an analysis unit of an image processing device 120 according to the second embodiment will be described. FIG. 9 is a second diagram illustrating an example of the functional configuration of the analysis unit of the image processing device. As illustrated in FIG. 9, an analysis unit 900 includes an input unit/decoding unit 310, a CNN unit 910, a signal intensity calculation unit 920, a quantization value map generation unit 930, and an output unit 360.

Among these, the input unit/decoding unit 310 and the output unit 360 have functions similar to those of the input unit/decoding unit 310 and the output unit 360 in FIG. 3, and thus, description thereof is omitted here.

The CNN unit 910 includes a trained model that performs recognition processing. The CNN unit 910 causes the trained model to be executed by inputting image data or decoded data. Furthermore, the CNN unit 910 notifies the quantization value map generation unit 930 of a recognition result output from the trained model by inputting the image data. Moreover, the CNN unit 910 outputs a feature map from a layer of a hidden layer when the trained model is executed.

The signal intensity calculation unit 920 acquires the feature map output from the CNN unit 910, aggregates signal intensity of the acquired feature map in units of blocks to calculate a degree of influence of each block of the image data on the recognition result, and stores the calculated degree of influence in a signal intensity storage unit 940. Note that, when aggregating the signal intensity of the feature map in units of blocks, the signal intensity calculation unit 920 calculates an error between two specified feature maps and backpropagates the calculated error, thereby acquiring an error back propagation result from an input layer of the trained model. Then, the signal intensity calculation unit 920 generates a block map specifying a positional relationship between each area of the feature maps and each block of the image data from a correspondence relationship between the acquired “error back propagation result” and the “error between the feature maps”.

The signal intensity calculation unit 920 aggregates the signal intensity of the feature map in units of blocks by using the generated block map to calculate the degree of influence of each block of the image data on the recognition result.

The quantization value map generation unit 930 generates a quantization value map while sequentially changing the quantization value for each block, and notifies the output unit 360 of the generated quantization value map. Furthermore, the quantization value map generation unit 930 searches for a quantization value corresponding to the limit compression ratio for each block based on an aggregation result of the signal intensity stored in the signal intensity storage unit 940, to generate a provisional quantization value map. Furthermore, the quantization value map generation unit 930 notifies the output unit 360 of the generated provisional quantization value map.

Moreover, the quantization value map generation unit 930 generates object area information based on the recognition result acquired from the CNN unit 910, and notifies the output unit 360 of the generated object area information.

### <Specific Example of Processing of CNN Unit and Signal Intensity Calculation Unit>

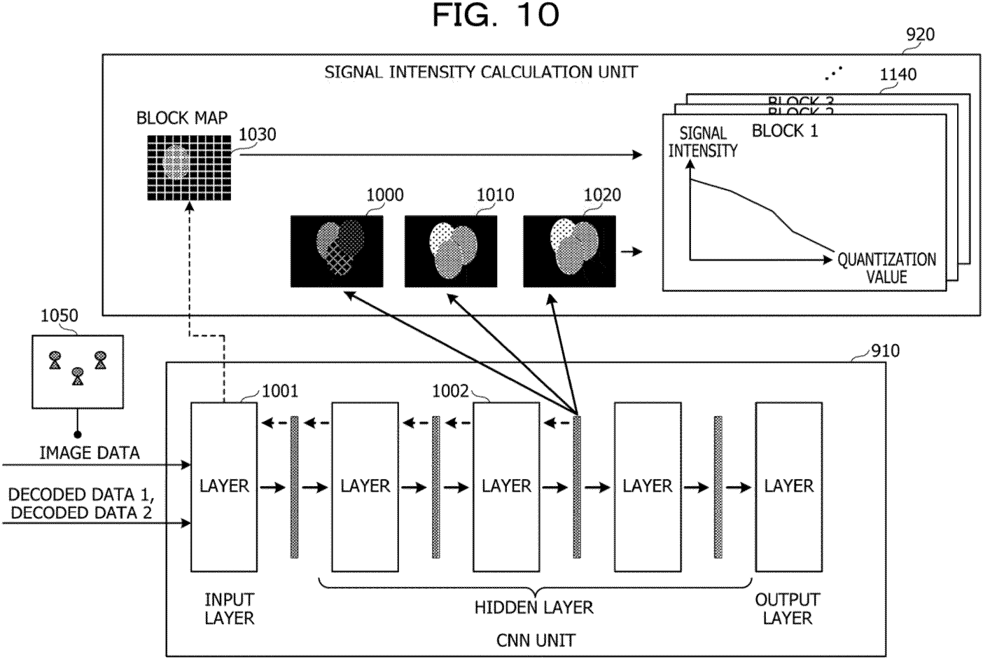

Next, a specific example of processing of the CNN unit 910 and the signal intensity calculation unit 920 among the respective units constituting the analysis unit 900 will be described. FIG. 10 is a diagram illustrating the specific example of the processing of the CNN unit and the signal intensity calculation unit.

As illustrated in FIG. 10, the CNN unit 910 includes an input layer, hidden layers, and an output layer as the trained model. When image data is input to a layer 1001 of the input layer of the CNN unit 910, the image data is processed in a forward propagation direction in each layer, and a feature map 1000 (an example of a first feature map) is output from a layer 1002 of the hidden layer (see a solid thick arrow). Note that the example of FIG. 10 indicates a state where image data 1050 including three “persons” which are examples of objects to be recognized is input.

Similarly, when decoded data 1 is input to the layer 1001 of the input layer, the decoded data 1 is processed in the forward propagation direction in each layer, and a feature map 1010 (an example of a second feature map) is output from the layer 1002 of the hidden layer (see a solid thick arrow). Note that the decoded data 1 refers to, for example, data obtained by performing the encoding processing for each block of the image data 1050 with a quantization value map that is a set of quantization values Q₁ and thereafter decoding the encoded data by the input unit/decoding unit 310.

Similarly, when decoded data 2 is input to the layer 1001 of the input layer, the decoded data 2 is processed in the forward propagation direction in each layer, and a feature map 1020 (another example of the second feature map) is output from the layer 1002 of the hidden layer (see a solid thick arrow). Note that the decoded data 2 refers to, for example, data obtained by performing the encoding processing for each block of the image data 1050 with a quantization value map that is a set of quantization values Q₂ and thereafter decoding the encoded data by the input unit/decoding unit 310.

Hereinafter, although not illustrated in FIG. 10, decoded data 3, decoded data 4, ..., and the like are similarly processed, and feature maps are output.

Here, in the signal intensity calculation unit 920, an error between the feature map 1000 and the feature map 1010 is calculated, and the calculated error is backpropagated from the layer 1002 of the hidden layer. With this configuration, an error back propagation result is output from the layer 1001 of the input layer of the CNN unit 910.

In the signal intensity calculation unit 920, from a correspondence relationship between
the error back propagation result output from the layer 1001 of the input layer, and
the error between the feature map 1000 and the feature map 1010,
a block map 1030 that specifies a positional relationship indicating to which block among the respective blocks of the image data the signal intensity of each area of the feature maps (the feature maps 1000, 1010, 1020, ...) output from the layer 1002 of the hidden layer corresponds is generated.

Furthermore, in the signal intensity calculation unit 920, the signal intensity of each feature map output from the layer 1002 of the hidden layer is aggregated in units of blocks based on the block map 1030, and a graph 1040 indicating a change in the signal intensity for each block is generated. The graph 1040 is a graph with the quantization value on a horizontal axis and the signal intensity is on a vertical axis, and indicates that the larger the signal intensity, the higher the degree of influence on the recognition result. In the signal intensity calculation unit 920, the generated graph 1040 is stored in the signal intensity storage unit 940.

With this configuration, the quantization value map generation unit 930 determines, for example, the quantization value that satisfies any of the following conditions:
in a case where magnitude of the signal intensity falls below a predetermined threshold,
in a case where an amount of change in the signal intensity exceeds a predetermined threshold,
in a case where a slope of the signal intensity exceeds a predetermined threshold, or
in a case where a change in the slope of the signal intensity exceeds a predetermined threshold,
as the quantization value corresponding to the limit compression ratio of each block.

### <Flow of Image Processing>

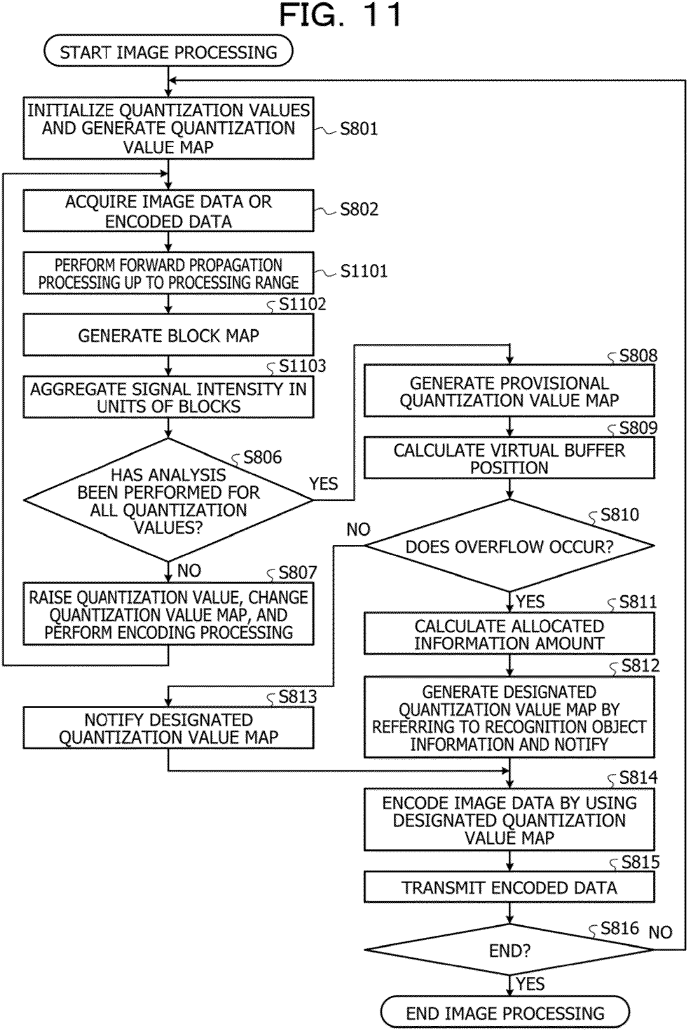

Next, a flow of image processing by the image processing device 120 will be described. FIG. 11 is a second flowchart illustrating the flow of the image processing by the image processing device. Differences from the first flowchart described with reference to FIG. 8 are Steps S1101 to S1103.

In Step S1101, the analysis unit 900 processes the image data or the decoded data up to a predetermined processing range in the forward propagation direction, and outputs feature maps from the layer of the hidden layer.

In Step S1102, in a case where the image data or the decoded data being processed is an object to be subjected to error back propagation (for example, the image data or the decoded data 1), the analysis unit 900 calculates an error between the feature maps and backpropagates the calculated error up to the input layer. Furthermore, the analysis unit 900 generates a block map by using an error back propagation result output from the input layer.

In Step S1103, the analysis unit 900 aggregates signal intensity of each area of the feature maps output in Step S1101 in units of blocks by using the generated block map.

As is clear from the above description, the image processing device 120 according to the second embodiment determines the quantization value corresponding to the limit compression ratio for each block by aggregating the signal intensity of each area of the feature maps output from the layer of the hidden layer in units of blocks.

With this configuration, according to the second embodiment, an effect similar to that of the first embodiment described above may be achieved.

### Third Embodiment

In the first and second embodiments described above, a case has been described where it is determined whether or not the overflow occurs in the virtual buffer after the provisional quantization value map is generated, and the quantization value of the provisional quantization value map is changed in a case where it is determined that the overflow occurs.

On the other hand, in a third embodiment, first, a case will be described where it is determined whether or not overflow occurs in a virtual buffer, and in a case where it is determined that the overflow occurs, a quantization value is changed by correcting an important feature map. Hereinafter, regarding the third embodiment, differences from the first and second embodiments described above will be mainly described.

### <System Configuration of Image Processing System>

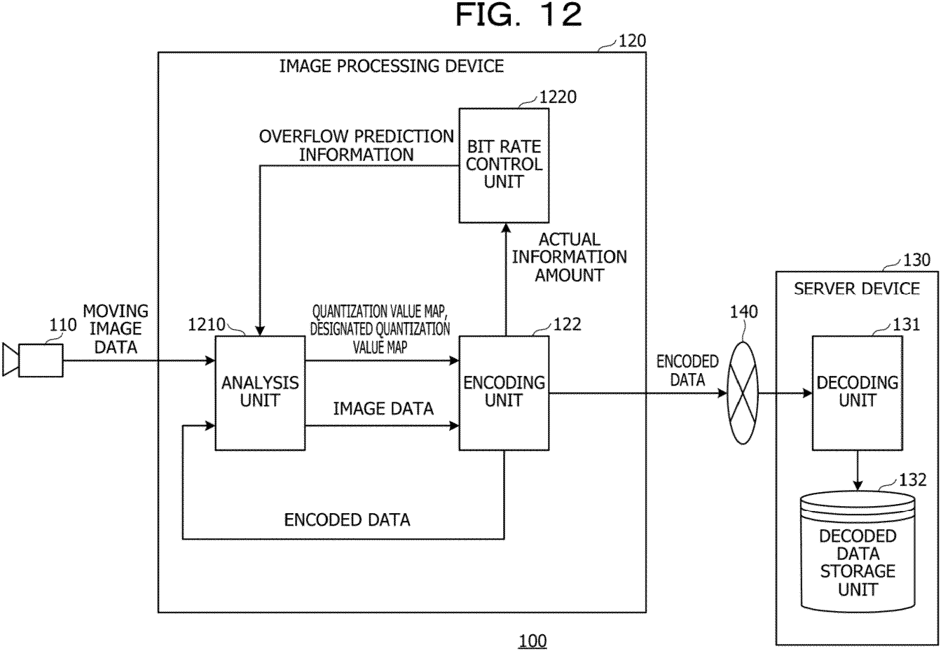

First, a system configuration of an entire image processing system including an image processing device according to the third embodiment will be described. FIG. 12 is a second diagram illustrating an example of the system configuration of the image processing system. Differences from the image processing system 100 in FIG. 1 are, in the case of an image processing system 100 in FIG. 12, functions of an analysis unit 1210 and a bit rate control unit 1220 implemented by an image processing device 120 are different from the functions of the analysis unit 121 and the bit rate control unit 123 in FIG. 1. Thus, hereinafter, the functions of the analysis unit 1210 and the bit rate control unit 1220 will be described.

The analysis unit 1210 is another example of the change unit, and includes a trained model that performs recognition processing. The analysis unit 1210 performs the recognition processing by inputting image data or decoded data of each frame of moving image data to the trained model.

Furthermore, at the time of the recognition processing, the analysis unit 1210 generates an important feature map by performing motion analysis of the trained model by using, for example, the error back propagation method. At that time, the analysis unit 1210 determines whether or not overflow prediction information is notified from the bit rate control unit 1220.

In a case where it is determined that the overflow prediction information is not notified, the analysis unit 1210 aggregates a degree of influence in units of blocks for the generated important feature map.

On the other hand, in a case where it is determined that the overflow prediction information is notified, the analysis unit 1210 refers to recognition object information and specifies an object to be recognized other than an object to be recognized specified by the recognition object information in advance among objects to be recognized included in the image data. Furthermore, the analysis unit 1210 performs correction for invalidating the degree of influence of a position corresponding to an area of the specified object to be recognized for the important feature map. Then, the analysis unit 1210 aggregates the degree of influence in units of blocks for the corrected important feature map subjected to the correction for invalidating the degree of influence.

Furthermore, the analysis unit 1210 instructs an encoding unit 122 to perform encoding processing with a predetermined number of different quantization values, and repeats processing similar to that described above for each piece of decoded data obtained by decoding encoded data of a case where the encoding processing is performed for the image data with each quantization value.

For example, while changing image quality of the image data input to the trained model by changing a quantization value map, the analysis unit 1210 aggregates the degree of influence of each block on a recognition result, for each piece of the image data after the change. At that time, it is determined whether or not the overflow prediction information is notified, and in a case where the overflow prediction information is notified, the correction for invalidating the degree of influence is performed.

Furthermore, the analysis unit 1210 searches for a quantization value corresponding to a limit compression ratio for each block based on a change in an aggregated value due to the change in the quantization value map, to generate a designated quantization value map. Moreover, the analysis unit 121 notifies the encoding unit 122 of the generated designated quantization value map.

The bit rate control unit 1220 is another example of the determination unit, and calculates a virtual buffer position based on an actual information amount. Furthermore, the bit rate control unit 1220 determines whether or not the calculated virtual buffer position exceeds a predetermined threshold, and in a case where it is determined that the calculated virtual buffer position exceeds the predetermined threshold, notifies the analysis unit 1210 of the overflow prediction information.

### <Functional Configuration of Analysis Unit of Image Processing Device>

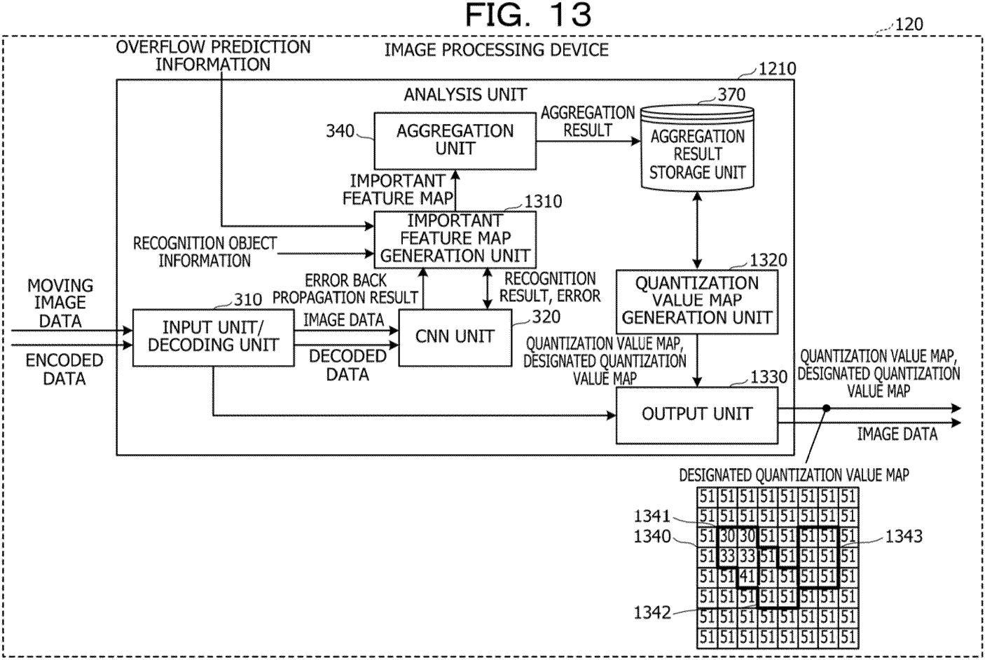

Next, a functional configuration of the analysis unit 1210 of the image processing device 120 will be described. FIG. 13 is a third diagram illustrating an example of the functional configuration of the analysis unit of the image processing device. As illustrated in FIG. 13, the analysis unit 1210 includes an input unit/decoding unit 310, a CNN unit 320, an important feature map generation unit 1310, an aggregation unit 340, a quantization value map generation unit 1320, and an output unit 1330.

Among these, the input unit/decoding unit 310, the CNN unit 320, and the aggregation unit 340 have functions similar to those of the input unit/decoding unit 310, the CNN unit 320, and the aggregation unit 340 in FIG. 3, and thus, description thereof is omitted here.

The important feature map generation unit 1310 acquires a recognition result output from the trained model of the CNN unit 320. Furthermore, the important feature map generation unit 1310 generates an important feature map by the error back propagation method by using the acquired recognition result.

For example, the important feature map generation unit 1310 calculates an error between a recognition result acquired when image data is input and a recognition result acquired when decoded data is input. Furthermore, the important feature map generation unit 1310 acquires an error back propagation result from an input layer of the trained model by backpropagating the calculated error. Moreover, the important feature map generation unit 1310 generates an important feature map based on the acquired error back propagation result.

At this time, the important feature map generation unit 1310 determines whether or not the overflow prediction information is notified from the bit rate control unit 1220. In a case where it is determined that the overflow prediction information is not notified, the important feature map generation unit 1310 notifies the aggregation unit 340 of the generated important feature map.

On the other hand, in a case where it is determined that the overflow prediction information is notified from the bit rate control unit 1220, the important feature map generation unit 1310 refers to the recognition object information. Then, the important feature map generation unit 1310 corrects the important feature map so as to invalidate the degree of influence of the position corresponding to the area of the object to be recognized other than the object to be recognized specified by the recognition object information in the generated important feature map. Moreover, the important feature map generation unit 1310 notifies the aggregation unit 340 of the corrected important feature map subjected to the correction for invalidating the degree of influence.

In this manner, in a case where it is determined that the overflow prediction information is notified, the important feature map generation unit 1310 invalidates the degree of influence of the position corresponding to the area of the object to be recognized other than the object to be recognized specified in advance in the important feature map. With this configuration, as a result, the encoding processing is performed for the area at a compression ratio exceeding a compression ratio (limit compression ratio) that would be determined based on an aggregation result in a case where the degree of influence is aggregated without being invalidated. As a result, it is possible to maintain recognition accuracy for the object to be recognized specified in advance while avoiding the overflow in the virtual buffer. For example, it is possible to suppress deterioration in the recognition accuracy in a case where encoding is performed at the compression ratio exceeding the limit compression ratio that may be recognized by AI.

The quantization value map generation unit 1320 generates a quantization value map while sequentially changing the quantization value for each block, and notifies the output unit 1330 of the generated quantization value map. Furthermore, the quantization value map generation unit 1320 searches for a quantization value corresponding to the limit compression ratio for each block based on an aggregation result stored in the aggregation result storage unit 370, to generate a designated quantization value map, and notifies the output unit 1330 of the generated designated quantization value map.

The output unit 1330 notifies the encoding unit 122 of the quantization value map generated by the quantization value map generation unit 1320. Furthermore, the output unit 1330 notifies the encoding unit 122 of the designated quantization value map generated by the quantization value map generation unit 1320. Moreover, the output unit 1330 notifies the encoding unit 122 of image data of a corresponding frame of moving image data.

Note that, in FIG. 13, a reference sign 1340 indicates an example of the designated quantization value map in a case where it is determined that the overflow prediction information is notified. In the example of the reference sign 1340, among objects to be recognized 1341 to 1343, quantization values of blocks at positions corresponding to areas of the objects to be recognized 1342 and 1343 other than the object to be recognized 1341 specified in the recognition object information are the maximum.

### <Functional Configuration of Bit Rate Control Unit>

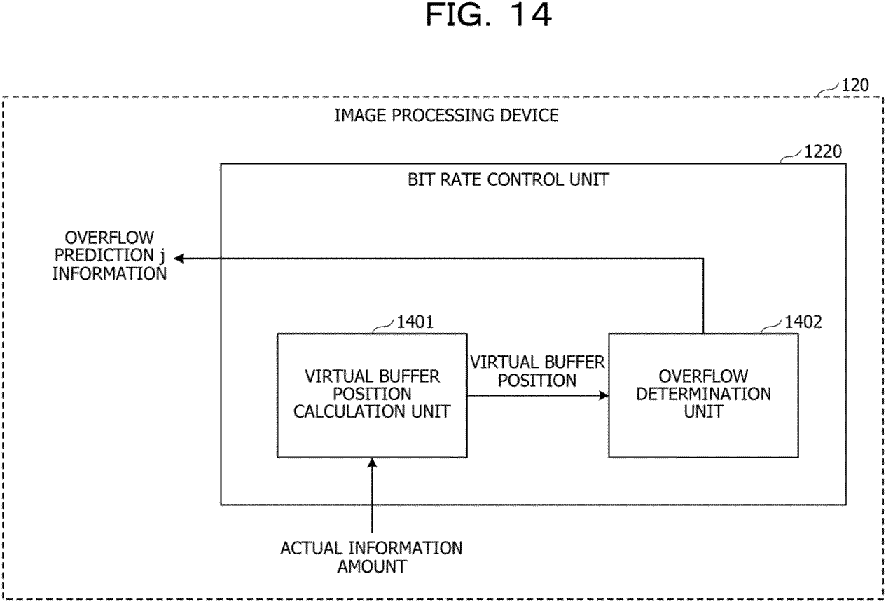

Next, a functional configuration of the bit rate control unit 1220 of the image processing device 120 will be described. FIG. 14 is a second diagram illustrating an example of the functional configuration of the bit rate control unit of the image processing device. As illustrated in FIG. 14, the bit rate control unit 1220 includes a virtual buffer position calculation unit 1401 and an overflow determination unit 1402.

The virtual buffer position calculation unit 1401 calculates a virtual buffer position based on the actual information amount acquired from the encoding unit 122. Furthermore, the virtual buffer position calculation unit 1401 notifies the overflow determination unit 1402 of the calculated virtual buffer position.

The overflow determination unit 1402 determines whether or not the virtual buffer position notified from the virtual buffer position calculation unit 1401 is a predetermined threshold or more. In a case where it is determined that the virtual buffer position is less than the predetermined threshold, the overflow determination unit 1402 determines that a possibility of occurrence of overflow is low. On the other hand, in a case where it is determined that the virtual buffer position is the predetermined threshold or more, the overflow determination unit 1402 determines that there is a high possibility that the overflow occurs and notifies the analysis unit 1210 of the overflow prediction information.

### <Flow of Image Processing>

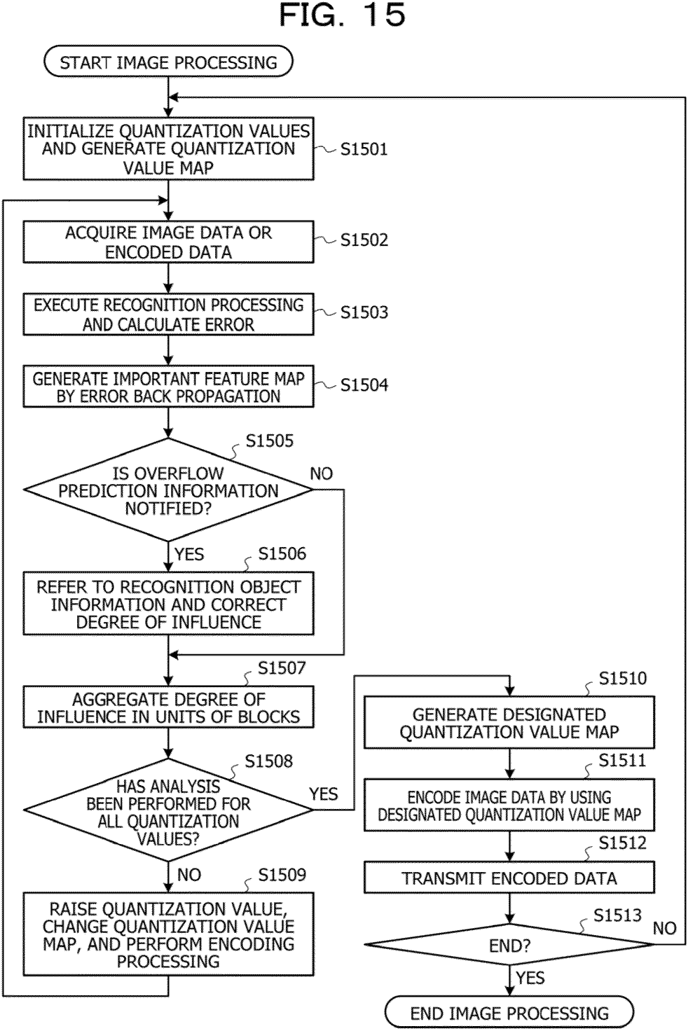

Next, a flow of image processing by the image processing device 120 will be described. FIG. 15 is a third flowchart illustrating the flow of the image processing by the image processing device.

In Step S1501, the analysis unit 1210 initializes quantization values and generates a default quantization value map.

In Step S1502, the analysis unit 1210 acquires image data or encoded data. Furthermore, in a case where the encoded data is acquired, the analysis unit 1210 decodes the encoded data and generates decoded data.

In Step S1503, the analysis unit 1210 performs the recognition processing for the image data or the decoded data, and outputs a recognition result. Furthermore, the analysis unit 1210 calculates an error between the recognition result output by performing the recognition processing for the image data and the recognition result output by performing the recognition processing for the decoded data.

In Step S1504, the analysis unit 1210 generates an important feature map by backpropagating the calculated error.

In Step S1505, the analysis unit 1210 determines whether or not overflow prediction information is notified from the bit rate control unit 1220. In a case where it is determined in Step S1505 that the overflow prediction information is notified (in the case of YES in Step S1505), the processing proceeds to Step S1506.

In Step S1506, the analysis unit 1210 refers to the recognition object information and specifies an object to be recognized other than an object to be recognized specified by the recognition object information in advance among objects to be recognized included in the image data. Furthermore, the analysis unit 1210 performs correction for invalidating a degree of influence of a position corresponding to an area of the specified object to be recognized in the important feature map, generates the corrected important feature map, and then proceeds to Step S1507.

On the other hand, in a case where it is determined in Step S1505 that the overflow prediction information is not notified (in the case of NO in Step S1505), the processing directly proceeds to Step S1507.

In Step S1507, the analysis unit 1210 aggregates the degree of influence in units of blocks for either the important feature map generated in Step S1504 or the corrected important feature map corrected in Step S1506.

In Step S1508, the analysis unit 1210 determines whether or not analysis has been performed for all the predetermined number of quantization values that are settable in the encoding unit 122. In a case where it is determined in Step S1508 that there is a quantization value for which analysis has not been performed (in the case of NO in Step S1508), the processing proceeds to Step S1509.

In Step S1509, the analysis unit 1210 raises the quantization value and changes the quantization value map. Furthermore, the encoding unit 122 performs the encoding processing for the image data by using the changed quantization value map and generates encoded data. Thereafter, the processing returns to Step S1502.

On the other hand, in a case where it is determined in Step S1508 that analysis has been performed for all the quantization values (in the case of YES in Step S1508), the processing proceeds to Step S1510.

In Step S1510, the analysis unit 1210 searches for a quantization value corresponding to the limit compression ratio for each block and generates a designated quantization value map. The analysis unit 1210 notifies the encoding unit 122 of the generated designated quantization value map.

In Step S1511, the encoding unit 122 performs the encoding processing for the image data of the frame to be processed by using the notified designated quantization value map and generates encoded data.

In Step S1512, the encoding unit 122 transmits the generated encoded data to the server device 130.

In Step S1513, the analysis unit 1210 determines whether or not the image processing is to be ended. In a case where it is determined in Step S1513 that the image processing is not to be ended (in the case of NO in Step S1513), the processing returns to Step S1501. In this case, the analysis unit 1210 initializes the quantization values and generates a default quantization value map before image data of the next frame in the moving image data is acquired.

On the other hand, in a case where it is determined in Step S1513 that the image processing is to be ended (in the case of YES in Step S1513), the image processing is ended.

As is clear from the above description, the image processing device 120 according to the third embodiment determines whether or not the overflow occurs in the virtual buffer when performing the encoding processing for the image data of the frame to be processed of the moving image data. Furthermore, the image processing device 120 according to the third embodiment refers to the recognition object information in a case where it is determined that the overflow occurs. Moreover, the image processing device 120 according to the third embodiment corrects the important feature map by invalidating the degree of influence of the position corresponding to the area of the object to be recognized other than the object to be recognized specified by the recognition object information in advance among the objects to be recognized included in the image data.

With this configuration, in the third embodiment, in a case where it is determined that the overflow occurs in the virtual buffer, the encoding processing is performed at the compression ratio exceeding the limit compression ratio for the area of the object to be recognized other than the specified object to be recognized.

As a result, according to the third embodiment, it is possible to maintain the recognition accuracy for the object to be recognized specified in advance while avoiding the overflow in the virtual buffer. For example, according to the third embodiment, it is possible to suppress deterioration in the recognition accuracy in a case where encoding is performed at the compression ratio exceeding the limit compression ratio that may be recognized by the AI.

### Fourth Embodiment

In the third embodiment described above, a case has been described where the important feature map is corrected in a case where it is determined that the overflow occurs in the virtual buffer.

On the other hand, in a fourth embodiment, a case will be described where an aggregation result for each block regarding signal intensity of each area of a feature map is corrected in a case where it is determined that overflow occurs in a virtual buffer.

Hereinafter, regarding the fourth embodiment, differences from the second or third embodiment described above will be mainly described.

### <Functional Configuration of Analysis Unit of Image Processing Device>

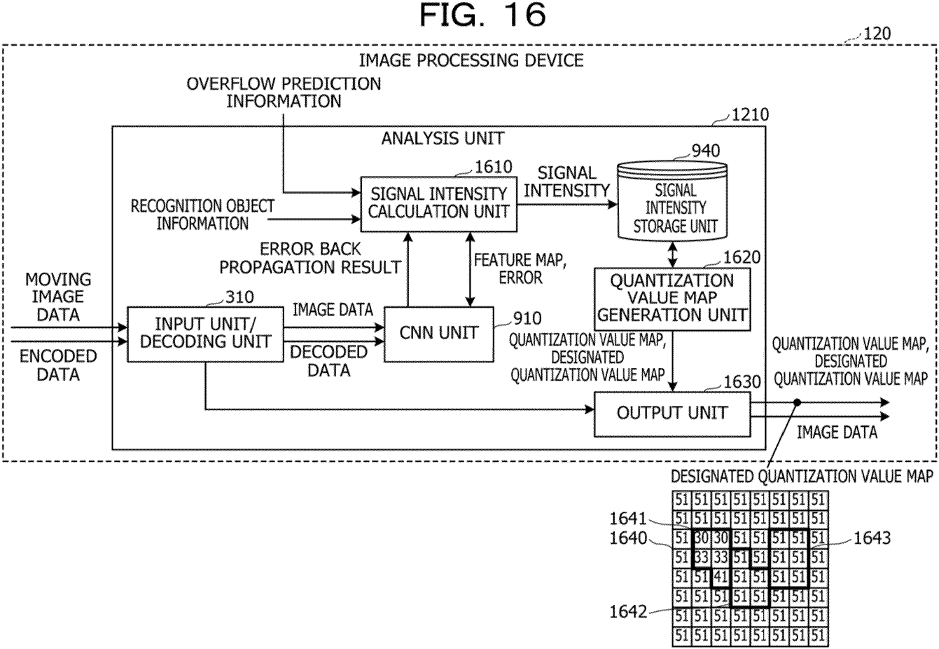

First, a functional configuration of an analysis unit 1210 of an image processing device 120 according to the fourth embodiment will be described. FIG. 16 is a fourth diagram illustrating an example of the functional configuration of the analysis unit of the image processing device. As illustrated in FIG. 16, the analysis unit 1210 includes an input unit/decoding unit 310, a CNN unit 910, a signal intensity calculation unit 1610, a quantization value map generation unit 1620, and an output unit 1630.

Among these, the input unit/decoding unit 310 and the CNN unit 910 have functions similar to those of the input unit/decoding unit 310 in FIG. 3 and the CNN unit 910 in FIG. 9, and thus, description thereof is omitted here.

The signal intensity calculation unit 1610 acquires a feature map output from the CNN unit 910 and aggregates signal intensity of the acquired feature map in units of blocks to calculate a degree of influence of each block of image data on a recognition result. At that time, the signal intensity calculation unit 1610 determines whether or not overflow prediction information is notified from a bit rate control unit 1220.

In a case where it is determined that the overflow prediction information is not notified, the signal intensity calculation unit 1610 stores the signal intensity aggregated in units of blocks in a signal intensity storage unit 940.

On the other hand, in a case where it is determined that the overflow prediction information is notified, the signal intensity calculation unit 1610 refers to recognition object information and specifies an object to be recognized other than an object to be recognized specified by the recognition object information in advance among objects to be recognized included in the image data. Furthermore, the signal intensity calculation unit 1610 performs correction for invalidating signal intensity of a block at a position corresponding to an area of the specified object to be recognized among the signal intensity aggregated in units of blocks. Then, the signal intensity calculation unit 1610 stores the signal intensity of each block after the correction subjected to the correction for invalidating the signal intensity in the signal intensity storage unit 940.

The quantization value map generation unit 1620 generates a quantization value map while sequentially changing a quantization value for each block, and notifies the output unit 1630 of the generated quantization value map. Furthermore, the quantization value map generation unit 1620 searches for a quantization value corresponding to a limit compression ratio for each block based on an aggregation result of the signal intensity stored in the signal intensity storage unit 940, to generate a designated quantization value map. Furthermore, the quantization value map generation unit 1620 notifies the output unit 1630 of the generated designated quantization value map.

The output unit 1630 notifies an encoding unit 122 of the quantization value map generated by the quantization value map generation unit 1620. Furthermore, the output unit 1630 notifies the encoding unit 122 of the designated quantization value map generated by the quantization value map generation unit 1620. Moreover, the output unit 1630 notifies the encoding unit 122 of image data of a corresponding frame of moving image data.

Note that, in FIG. 16, a reference sign 1640 indicates an example of the designated quantization value map in a case where it is determined that the overflow prediction information is notified. In the example of the reference sign 1640, among objects to be recognized 1641 to 1643, quantization values of blocks at positions corresponding to areas of the objects to be recognized 1642 and 1643 other than the object to be recognized 1641 specified in the recognition object information are the maximum.

### <Flow of Image Processing>

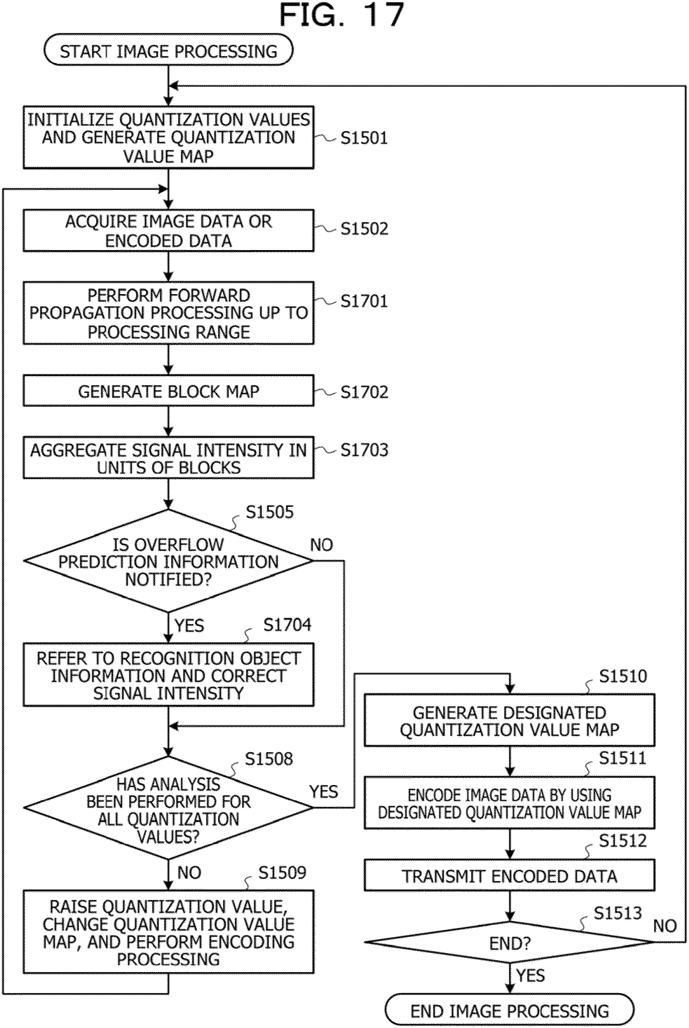

Next, a flow of image processing by the image processing device 120 will be described. FIG. 17 is a fourth flowchart illustrating the flow of the image processing by the image processing device. Differences from the third flowchart described with reference to FIG. 15 are Steps S1701 to S1703 and S1704.

In Step S1701, the analysis unit 1210 processes the image data or the decoded data up to a predetermined processing range in a forward propagation direction, and outputs feature maps from a layer of a hidden layer.

In Step S1702, in a case where the image data or the decoded data being processed is an object to be subjected to error back propagation (for example, the image data or decoded data 1), the analysis unit 1210 calculates an error between the feature maps and backpropagates the calculated error up to an input layer. Furthermore, the analysis unit 1210 generates a block map by using an error back propagation result output from the input layer.

In Step S1703, the analysis unit 1210 aggregates signal intensity of each area of the feature maps output in Step S1701 in units of blocks by using the generated block map.

In Step S1704, the analysis unit 1210 refers to the recognition object information and specifies an object to be recognized other than an object to be recognized specified by the recognition object information in advance among objects to be recognized included in the image data. Furthermore, the analysis unit 1210 performs correction for invalidating an aggregation result of signal intensity of a block at a position corresponding to an area of the specified object to be recognized among the signal intensity aggregated in units of blocks.

As is clear from the above description, the image processing device 120 according to the fourth embodiment corrects the aggregation result for each block regarding the signal intensity of each area of the feature map in a case where it is determined that overflow occurs in the virtual buffer.

With this configuration, according to the fourth embodiment, an effect similar to that of the third embodiment described above may be achieved.

### Fifth Embodiment

In each of the embodiments described above, the description has been made assuming that the recognition object information is fixed. However, the recognition object information may be variable, and may be switched in units of frames, for example. For example, it is assumed that first to third objects to be recognized are included as three objects to be recognized over a plurality of frames. In this case, when encoding processing is performed for image data of a first frame, the first object to be recognized is specified as the recognition object information, and when the encoding processing is performed for image data of a second frame, the second object to be recognized is specified as the recognition object information. Moreover, when the encoding processing is performed for image data of a third frame, the third object to be recognized is specified as the recognition object information.

In this manner, by sequentially changing the object to be recognized specified in the recognition object information, each of the first to third objects to be recognized is recognized at a rate of once in the three frames. In this case, for example, the first object to be recognized may be complemented in the image data of the second and third frames by using the image data of the first frame in which the first object to be recognized is recognized and image data of a fourth frame in which the first object to be recognized is recognized next.

Furthermore, in each of the embodiments described above, the number of layers included in the CNN unit is five due to space limitations, but the number of layers included in the CNN unit may be five or more.

Note that the embodiments are not limited to the configurations described here and may include, for example, combinations of the configurations or the like described in the embodiments described above and other elements. These points may be changed in a range not departing from the spirit of the embodiments and may be appropriately determined according to application modes thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image processing device comprising:
a memory; and
a processor coupled to the memory and configured to:
determine whether or not overflow occurs in a virtual buffer when image data of each frame of moving image data is encoded;
refer to recognition object information in a case where it is determined that the overflow occurs; and
change a quantization value of a block at a position that corresponds to an area of an object to be recognized other than an object to be recognized specified by the recognition object information among objects to be recognized included in the image data to a quantization value higher than a quantization value that corresponds to a limit compression ratio.

2. The image processing device according to claim 1, wherein the processor:
calculates a degree of influence of each block of the image data on a recognition result by backpropagating each error between a recognition result acquired by performing recognition processing for the image data and a recognition result acquired by performing the recognition processing for each of a plurality of pieces of decoded data obtained by decoding the image data after each piece of the image data is encoded by using different quantization values;
generates a provisional quantization value map of a quantization value that corresponds to the limit compression ratio by determining a quantization value of each block when the image data is encoded; and
changes the quantization value in the provisional quantization value map.

3. The image processing device according to claim 1, wherein the processor:
calculates a degree of influence of each block of the image data on a recognition result by backpropagating each error between a recognition result acquired by performing recognition processing for the image data and a recognition result acquired by performing the recognition processing for each of a plurality of pieces of decoded data obtained by decoding the image data after each piece of the image data is encoded by using different quantization values; and
changes the quantization value to the quantization value higher than the quantization value that corresponds to the limit compression ratio by correcting the degree of influence on the recognition result of the block at the position that corresponds to the area of the object to be recognized other than the object to be recognized specified by the recognition object information among the objects to be recognized included in the image data.

4. The image processing device according to claim 1, wherein the processor:
calculates a degree of influence of each block of the image data on a recognition result by acquiring a first feature map output from a hidden layer when recognition processing is performed for the image data and a plurality of second feature maps output from the hidden layer when the recognition processing is performed for each of a plurality of pieces of decoded data obtained by decoding the image data after each piece of the image data is encoded by using different quantization values, and aggregating signal intensity of each area of the first feature map and the plurality of second feature maps for each block;
generates a provisional quantization value map of the quantization value that corresponds to the limit compression ratio by determining a quantization value of each block when the image data is encoded and
changes the quantization value in the provisional quantization value map.

5. The image processing device according to claim 1, wherein the processor:
acquires a first feature map output from a hidden layer when recognition processing is performed for the image data and a plurality of second feature maps output from the hidden layer when the recognition processing is performed for each of a plurality of pieces of decoded data obtained by decoding the image data after each piece of the image data is encoded by using different quantization values;
calculates a degree of influence of each block of the image data on a recognition result by aggregating signal intensity of each area of the first feature map and the plurality of second feature maps for each block; and
changes the quantization value to the quantization value higher than the quantization value that corresponds to the limit compression ratio by correcting the degree of influence on the recognition result of the block at the position that corresponds to the area of the object to be recognized other than the object to be recognized specified by the recognition object information among the objects to be recognized included in the image data.

6. The image processing device according to claim 1, wherein the processor changes the quantization value according to an information amount allocated based on a virtual buffer position.

7. The image processing device according to claim 1, wherein the object to be recognized specified by the recognition object information is changed in units of frames.

8. The image processing device according to claim 1, wherein the processor encodes the image data by using the quantization value changed by the change unit.

9. An information processing method comprising:
determining whether or not overflow occurs in a virtual buffer when image data of each frame of moving image data is encoded;
referring to recognition object information in a case where it is determined that the overflow occurs; and
changing a quantization value of a block at a position that corresponds to an area of an object to be recognized other than an object to be recognized specified by the recognition object information among objects to be recognized included in the image data to a quantization value higher than a quantization value that corresponds to a limit compression ratio.

10. A non-transitory computer-readable recording medium storing an information processing program for causing a computer to execute a processing of:
determining whether or not overflow occurs in a virtual buffer when image data of each frame of moving image data is encoded;
referring to recognition object information in a case where it is determined that the overflow occurs; and
changing a quantization value of a block at a position that corresponds to an area of an object to be recognized other than an object to be recognized specified by the recognition object information among objects to be recognized included in the image data to a quantization value higher than a quantization value that corresponds to a limit compression ratio.
